(19) United States
(12) Patent Application Publication
(10) Pub. No.: US 2008/0146050 A1
(43) Pub. Date: Jun. 19, 2008

(54) Electrical Connector

(76) Inventor: Ted Ju, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/905,995

(22) Filed: Oct. 9, 2007

(30) Foreign Application Priority Data
Dec. 15, 2006 (CN) 200620154821.1

(51) Int. Cl. H01R 12/08

(52) U.S. Cl. 439/66

(57) ABSTRACT

An electrical connector includes an insulating body and a plurality of terminals, wherein the insulating body has a positioning structure for positioning the flexible circuit board. The flexible circuit board has a holding structure corresponding to the positioning structure. The terminals have a lower contacting portion protruding out of the insulating body. The flexible circuit board has an electric conduction trace in press-contact with the lower contacting portion. Furthermore, the electrical connector includes a clamping structure for pressing the flexible circuit board against to the insulating body. When the flexible circuit board is broken, users can detach the flexible circuit connector from the corresponding electrical component without damaging the flexible circuit board.

### BACKGROUND OF THE INVENTION

1. Field of the Invention

The present invention relates to an electrical connector, and in particular to an electrical connector that electrically connects a flexible circuit board with an electrical component.

2. Description of the Prior Art

A conventional electrical connector is provided for connecting a flexible circuit board with an electrical component. China Patent Publication No. CN00114934.2 discloses an electrical connector having an insulating body with a top wall and a bottom wall. The top wall is connected to the bottom via a corresponding side wall, and a space is formed therein. A plurality of terminals are installed in the insulating body. Each of the terminals has a contacting portion extending into the space, a fixing portion fixed on the insulating body, and a welding portion extending out of the insulating body welded to the flexible circuit board.

The prior art described above suffers from the following defect: When the electrical connector is wrong, it can not be changed because the terminals are welded on the flexible circuit board. If the electrical connector is detached, the flexible circuit board will be damaged.

### SUMMARY OF THE INVENTION

An object of the present invention is to provide an electrical connector that can be changed easily after being wrong and does not damage the flexible circuit board.

In order to achieve the above object, the present invention provides an electrical connector for connecting a flexible circuit board with an electrical component, comprising: an insulating body having a positioning structure for positioning the flexible circuit board; a plurality of terminals received in the insulating body, the terminals having a lower contacting portion protruding out of the insulating body for press-contacting with the flexible circuit board; and a clamping structure for pressing the insulating body against to the flexible circuit board.

Another object of the invention is described in the following. The present invention provides an electrical connector assembly that includes a flexible circuit board having a holding structure and a plurality of electric conduction traces; and an electrical connector comprising: an insulating body having an positioning structure for positioning the flexible circuit board, the holding structure of the flexible circuit board aligned with the positioning structure; a plurality of terminals mounted in the insulating body, the terminals having a lower contacting portion protruding out of the insulating body, the electric conduction traces of the flexible circuit board being in press-contact with the lower contacting portion; and a clamping structure for pressing the insulating body against to the flexible circuit board.

Another object of the invention is described in the following. The present invention provides an electrical connector that includes an insulating body and a plurality of terminals, wherein the insulating body has a structure for positioning the flexible circuit board. The flexible circuit board comprises holes, matching the holes in the fixing structure of the insulating body. One end of the terminals has two contacting portions one of which protrudes out of the insulating body. This first contacting portion is in press contact with the electric conduction traces. The second contacting portion connects another electronic component to the terminal. It is located at the opposite end of the terminal facing away from the circuit board.

### BRIEF DESCRIPTION OF THE DRAWINGS

FIG. 1 is a perspective view showing an electrical connector assembled with a flexible circuit board;

FIG. 2 is an exploded view showing the electrical connector of FIG. 1;

FIG. 3 is a perspective view showing an insulating body of the electrical connector of FIG. 1;

FIG. 4 is a front view of the electrical connector of FIG. 1;

FIG. 5 is a cross-sectional view, taken along the line B-B of FIG. 4;

FIG. 6 is a front view showing a terminal of the electrical connector of FIG. 1;

FIG. 7 is a front view of the second embodiment of the present invention;

FIG. 8 is a front view of the third embodiment of the electrical connector of the present invention;

FIG. 9 is a partial cross-sectional view (from the top) of the fourth embodiment showing a positioning structure of the insulating body corresponding to the flexible circuit board.

### DETAILED DESCRIPTION OF THE INVENTION

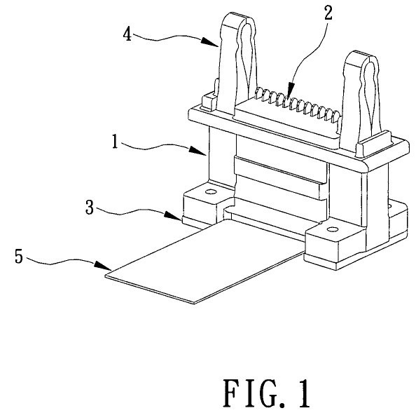

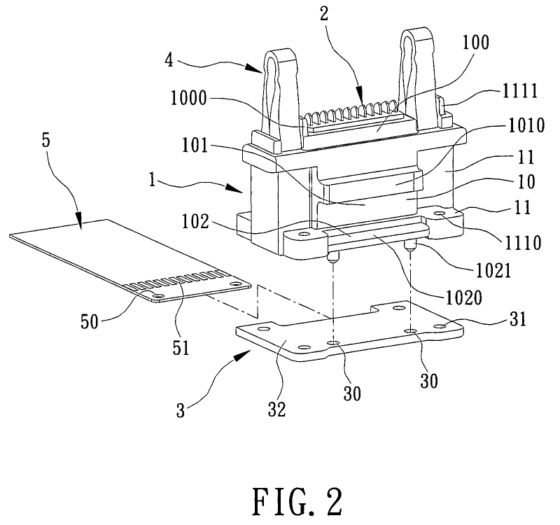

Please refer to FIG. 1 and FIG. 2, in which the present invention of an electrical connector for connecting a flexible circuit board 5 with an electrical component such as a printed circuit board (not shown) is disclosed. The electrical connector includes an insulating body 1, a plurality of terminals 2 mounted in the insulating body 1, a clamping structure 3 located between the flexible circuit board 5 and the insulating body 1, and a fixing device 4 for fixing the electrical connector to the electrical component.

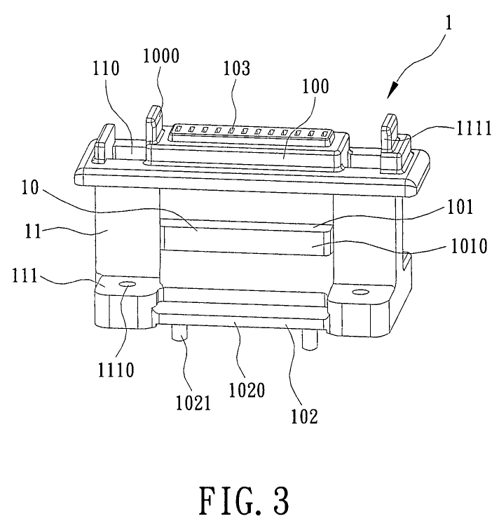

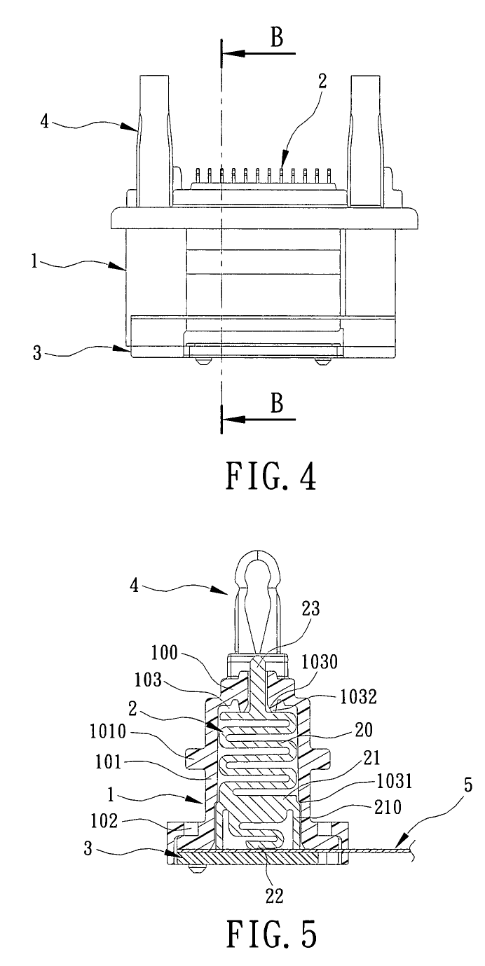

Refer to FIG. 2 and FIG. 3, the insulating body 1 includes a main portion 10 and two arm portions 11 located at the end of the main portion 10. The main portion 10 includes an upper portion 100, a middle portion 101 and a lower portion 102, wherein the upper portion 100 is tower shape, and the top of the upper portion 100 is narrower than the lower of the upper portion 100.

At the two ends of the upper portion 100 are located two tenon components 1000, 1111 extending upwards. The first tenon component 1000 and the second tenon component 1111 act together to ensure the correct connection between the electrical connector and the electrical component and prevent wrong insertion of the connector.

The middle portion 101 is shaped as a cuboid. A rib 1010 protrudes out of the rims of the middle portion 101. Two sides of the lower portion 102 extend outward to form two connecting plates 1020. The two connecting plates 1020 protrude downward to form a positioning structure 1021 (in the present embodiment, the positioning structure 1021 is a positioning post.).

Refer to FIG. 5, the main portion 10 has a plurity of receiving slots 103 penetrating the upper portion 100, extending into a cavity in the middle portion 101 downward to the lower portion 102. The upper part of the receiving slots 103 is narrow and their lower part (at the lower portion 102) is wide. In the narrow-wide boundary of each receiving slots 103 have a first step plane 1030 and a second step plane 1031. A pressing block 1032 forms in the length of each receiving slots 103 and the pressing block 1032 is near the first step plane 1030 protruding downward.

Refer to FIG. 5, in the approximately middle of the side arm portion 11 includes an insertion slot 110 for holding the fixing device 4. The four corners of the insulating body 1 have four ribs 111. Each rib 111 has a fixing hole 1110.

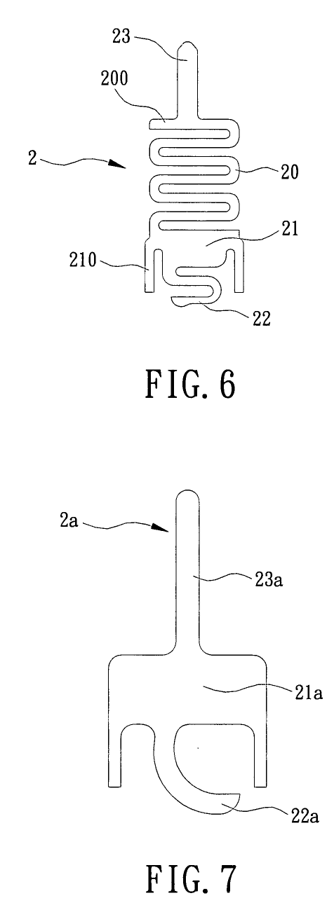

Refer to FIG. 5 and FIG. 6, the terminals 2 received in the corresponding receiving slots 103 includes a main body 21 and a flexible body 20 extending from the main body 21. The two sides of the main body 21 extend downward to form a stop portion 210. A lower contacting portion 22 forms on the lower end of the main body 21 is designed as a spring to ensure good pressing contact with the electrical conduction trace. The lower contacting portion 22 protrudes out of the bottom of the insulating body 1.

The flexible body 20 has a plurality serial of “S” shapes. The top of the flexible body 20 forms a beam 200 to prevent the terminals 2 from moving upward excessively. The beam 200 has a upper contacting portion 23 extending upward, the upper contacting portion 23 in press contacts with the corresponding electrical component movablely. The upper contacting portion 23 is similar to a probe, and it is movable vertically when the connector is compressed by movement of either the flexible circuit board 5 or the compression of the corresponding electronic component.

Please refer to FIG. 7, showing another embodiment of the terminals 2a. Each terminal 2a includes a main part 21a, a lower press-contact portion 22a and an upper press-contact portion 23a protruding from the two sides of the main part 21a.

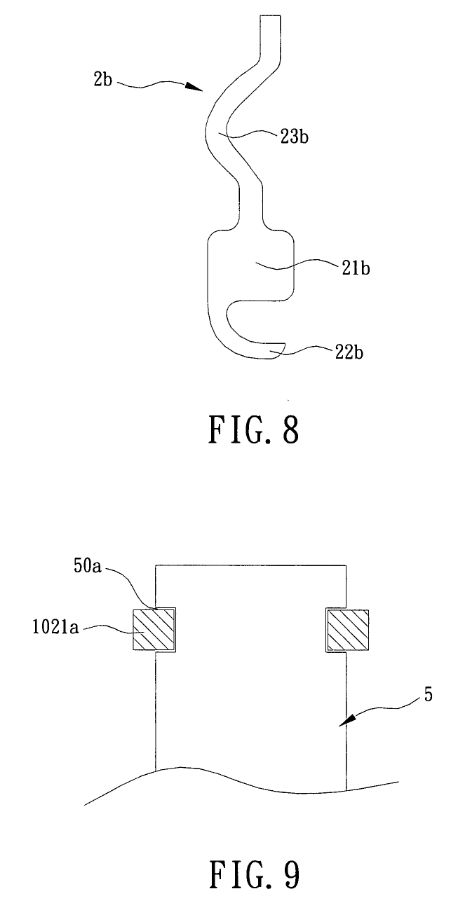

Please refer to FIG. 8, showing another embodiment of the terminals 2b. Each terminal 2b includes a main part 21b, a lower press-contact portion 22b extending from the lower end of the main body 21b and a flexible body 23b in contact with the corresponding electrical component extending from the upper end of the main part 21b.

Refer to FIG. 1 and FIG. 2, the clamping structure 3 includes a clamping plate 32 and a plurality of fixing members (not shown) which can clip the flexible circuit board 5 by locking together the clamping plate 32 and the insulating body 1. The clamping plate 32 is a rectangular shape, and it has a plurality of positioning holes 30 fitting with corresponding to the positioning structure 1021 of the connecting plates 1020. The connecting plates 1020 are used to position the clamping plate 32. The four corners of the clamping plate 32 have four locking holes 31. However, the clamping structure 3 can consist of the clamping plate 32 only. The clamping plate 32 has holes engaging with the insulating body 1.

Refer to FIG. 1 and FIG. 2, the flexible circuit board 5 has a holding structure 50 (in the present embodiment, the holding structure 50 is a receiving hole) fitting with the corresponding positioning structure 1021. The flexible circuit board 5 has a plurality of electric conduction trace 51 in press-contact with the lower contacting portion 22. The flexible circuit board 5 is positioned via the positioning structure 1021 corresponding to the holding structure 50.

When assembling, the terminals 2 are received in the corresponding receiving slots 103 firstly, and then the flexible circuit board 5 is mounted under the insulating body 1, whereby the receiving holes 50 of the flexible circuit board 5 are aligned with the positioning structure 1021. The positioning holes 30 of the clamping plate 32 engage with the positioning structure 1021. The locking holes 31 of the clamping plate 32 are facing the fixing holes 1110. A plurality of locking bolts (not shown) penetrate the fixing holes 1110 of the insulating body 1 and the locking holes 31 of the clamping plate 32. Thereby the insulating body 1 is fixed to the clamping plate 32 to clamp the flexible circuit board 5. When the flexible circuit board 5 compresses the terminals 2, the terminals 2 will move upward until the beam 200 of the terminal 2 contacts the pressing block 1032 and the stop portion 210 is pressed against the flexible circuit board 5. The latter prevents the lower contacting portion 22 to be deformed excessively.

### The fixing device 4 is inserted in the insertion slot 110. As a result, the electrical connector is connected and fixed to the corresponding electronic component via the tenon components 1000 and 1111 and the guidance of fixing device 4.

Please refer to FIG. 9 showing another embodiment of the positioning structure 1021, the positioning structure 1021 is a fastening block 1021a. Two fastening gaps 50a are formed at two sides of the flexible circuit board 5. This achieves the same effect as the positioning structure 1021 through the alignment of the positioning structure with the fastening gaps 50a. As a result, the flexible circuit board 5 is aligned with the insulating body 1.

What is claimed is:

1. An electrical connector for connecting a flexible circuit board with an electrical component, comprising:
an insulating body having a positioning structure for positioning the flexible circuit board;
a plurality of terminals received in the insulating body, the terminals having a lower contacting portion protruding out of the insulating body for press-contacting with the flexible circuit board; and
a clamping structure for pressing the insulating body against to the flexible circuit board.

2. The electrical connector as claimed in claim 1, wherein the positioning structure defines a plurality of positioning posts.

3. The electrical connector as claimed in claim 1, wherein the positioning structure is a fastening block.

4. The electrical connector as claimed in claim 3, wherein the fastening blocks are at two sides of the bottom of the insulating body.

5. The electrical connector as claimed in claim 1, wherein the clamping structure is a clamping plate.

6. The electrical connector as claimed in claim 1, wherein the clamping structure has the clamping plate and a plurality of fixed members for fixing the flexible circuit board.

7. The electrical connector as claimed in claim 6, wherein the clamping plate is formed with a plurality of position holes corresponding to the positioning structure are used to position the clamping plate.

8. The electrical connector as claimed in claim 1, wherein the terminals comprise a main portion and a flexible portion extending from the main portion, the top of the flexible portion forming a beam to prevent the terminals from moving upward excessively.

9. The electrical connector as claimed in claim 8, wherein the beam has an upper contacting portion extending upward, the upper contacting is movable.

10. An electrical connector assembly, comprising:
a flexible circuit board having a holding structure and a plurality of electric conduction traces;
an electrical connector comprising:
an insulating body having an positioning structure for positioning the flexible circuit board, the holding structure of the flexible circuit board aligned with the positioning structure;
a plurality of terminals mounted in the insulating body, the terminals having a lower contacting portion protruding out of the insulating body, the electric conduction traces of the flexible circuit board being in press-contact with the lower contacting portion; and
a clamping structure for pressing the insulating body against to the flexible circuit board.

11. The electrical connector assembly as claimed in claim 10, wherein the positioning structure comprises positioning posts, the holding structure comprises receiving holes, and the positioning posts are inserted into the receiving holes.

12. The electrical connector assembly as claimed in claim 10, wherein the positioning structure is a fastening block, the holding structure comprises fastening gaps, and the fastening blocks are inserted into the fastening gaps.

13. The electrical connector assembly as claimed in claim 12, wherein the fastening blocks are at two sides of the bottom of the insulating body, and the fastening gaps are at the two sides of the flexible circuit board.

14. The electrical connector assembly as claimed in claim 10, wherein the clamping structure is a clamping plate.

15. The electrical connector assembly as claimed in claim 10, wherein the clamping structure has the clamping plate and a plurality of fixed members for fixing the flexible circuit board.

16. The electrical connector assembly as claimed in claim 15, wherein the clamping plate is formed with a plurality of position holes corresponding to the positioning structure are used to position the clamping plate.

17. The electrical connector assembly as claimed in claim 10, wherein the terminals comprise a main portion and a flexible portion extending from the main portion, the top of the flexible portion forming a beam to prevent the terminals from moving upward excessively.

18. The electrical connector assembly as claimed in claim 17, wherein the beam has an upper contacting portion extending upward, the upper contacting is movable.

19. An electrical connector for connecting a flexible circuit board with an electrical component, comprising
an insulating body having an position structure for positioning the flexible circuit board, the flexible circuit board having a holding structure corresponding to the positioning structure;
a plurality of terminals mounted in the insulating body, the terminals having a lower contacting portion protruding out of the insulating body, the flexible circuit board having an electric conduction trace in press-contacts with the lower contacting portion, the terminals having a main portion, the lower contacting portion extending from the lower end of the main portion, an upper contacting portion which is in contact with the electrical component extending from the upper end of the main portion; and
a clamping structure for fixing the insulating body to the flexible circuit board.
